(19) United States
(12) Patent Application Publication
(10) Pub. No.: US 2024/0380520 A1
(43) Pub. Date: Nov. 14, 2024

(54) HARQ CODEBOOK FOR MULTI-TB TRANSMISSION

(71) Applicant: QUALCOMM INCORPORATED, San Diego, CA (US)

(72) Inventors: Fang YUAN, Beijing (CN); Yan ZHOU, San Diego, CA (US); Sony AKKARAKARAN, Poway, CA (US); Tao LUO, San Diego, CA (US)

(21) Appl. No.: 18/285,114

(22) PCT Filed: May 18, 2021
(86) PCT No.: PCT/CN2021/094276

§ 371 Date: Sep. 29, 2023

(51) Int. Cl. H04L 1/1812; H04L 1/1829; H04W 72/232

(52) U.S. Cl. CPC H04L 1/1812; H04L 1/1861; H04W 72/232

(57) ABSTRACT

This disclosure provides systems, devices, apparatus, and methods, including computer programs encoded on storage media, for a HARQ codebook for multi-TB transmission. A UE may receive, from a base station, DCI including at least one of a DAI indicator or a TB counter indicator, such that the UE may determine, based on the at least one of the DAI indicator or the TB counter indicator, a number of ACK/NACK bits for the HARQ codebook. The UE may transmit, to the base station, the HARQ codebook including the determined number of ACK/NACK bits.

### TECHNICAL FIELD

The present disclosure relates generally to communication systems, and more particularly, to a hybrid automatic repeat request (HARQ) codebook for multi-transport block (TB) transmission.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may receive, from a base station, downlink control information (DCI) including at least one of a downlink assignment index (DAI) indicator or a transport block (TB) counter indicator; determine, based on the at least one of the DAI indicator or the TB counter indicator, a number of acknowledgment/negative acknowledgment (ACK/NACK) bits for a hybrid automatic repeat request (HARQ) codebook; and transmit, to the base station, the HARQ codebook including the number of ACK/NACK bits.

In an aspect of the disclosure, a method, a computer-readable medium, and an apparatus are provided. The apparatus may transmit, to a user equipment (UE), DCI including at least one of a DAI indicator or a TB counter indicator; and receive, from the UE based on the at least one of the DAI indicator or the TB counter indicator, a HARQ codebook including a number of ACK/NACK bits for the HARQ codebook.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a call flow diagram illustrating communications between a UE and a base station.

FIG. 5 is a diagram illustrating downlink control information (DCI) that schedules a plurality of transport blocks (TBs).

FIG. 6 is a diagram illustrating hybrid automatic repeat request (HARQ) codebook tables that are generated based on DCI tables.

FIG. 7 illustrates tables indicative of HARQ codebooks configured in association with multi-TB transmissions.

FIG. 8 illustrates tables indicative of HARQ codebook generation procedures associated with a lost DCI in a previous number of DCIs.

FIG. 9 illustrates tables indicative of HARQ codebook generation procedures associated with a plurality of lost DCIs in a previous number of DCIs.

FIG. 10 is a flowchart of a method of wireless communication at a UE.

FIG. 11 is a flowchart of a method of wireless communication at a UE.

FIG. 12 is a flowchart of a method of wireless communication at a base station.

FIG. 13 is a diagram illustrating an example of a hardware implementation for an example apparatus.

FIG. 14 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

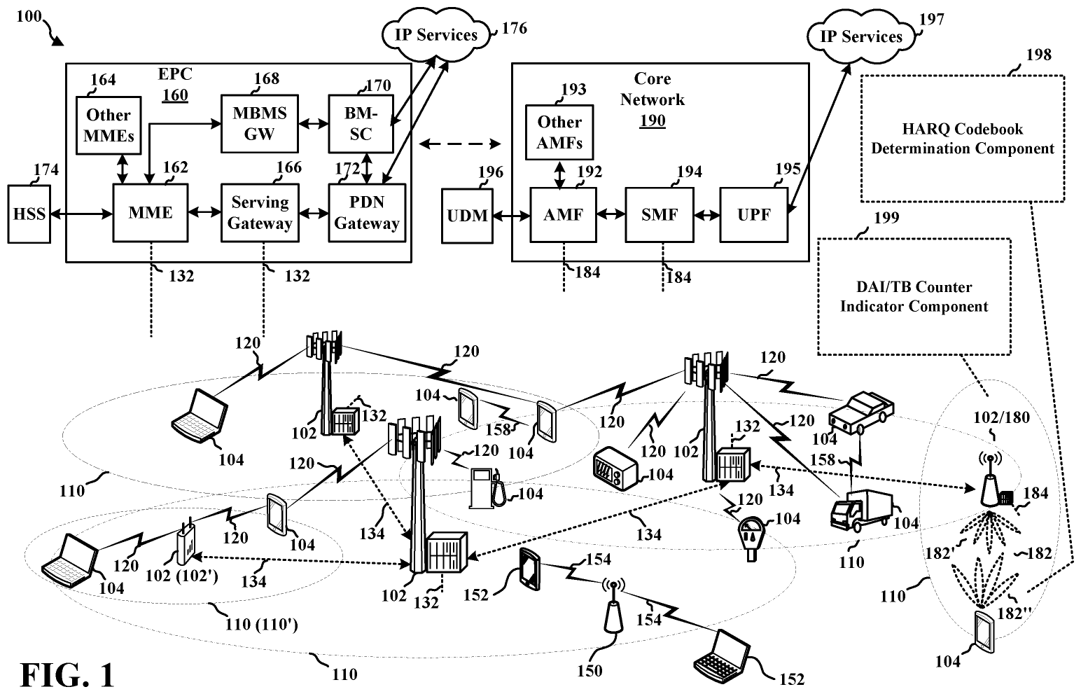

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a hybrid automatic repeat request (HARQ) codebook determination component 198 configured to receive, from a base station, downlink control information (DCI) including at least one of a downlink assignment index (DAI) indicator or a transport block (TB) counter indicator; determine, based on the at least one of the DAI indicator or the TB counter indicator, a number of acknowledgment/negative acknowledgment (ACK/NACK) bits for a HARQ codebook; and transmit, to the base station, the HARQ codebook including the number of ACK/NACK bits. In certain aspects, the base station 180 may include a DAI/TB counter indicator component 199 configured to transmit, to a UE, DCI including at least one of a DAI indicator or a TB counter indicator; and receive, from the UE based on the at least one of the DAI indicator or the TB counter indicator, a HARQ codebook including a number of ACK/NACK bits for the HARQ codebook. Although the following description may be focused on 5G NR, the concepts described herein may be applicable to other similar areas, such as LTE, LTE-A, CDMA, GSM, and other wireless technologies.

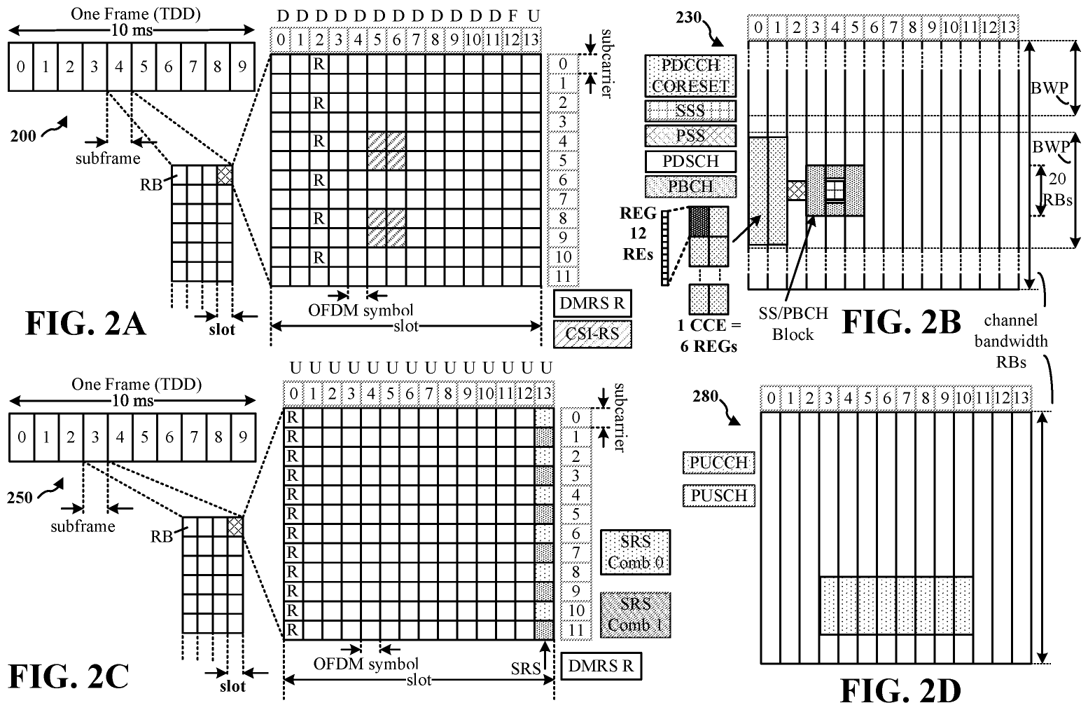

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DCI, or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2^{μ} · 15 [kHz] | prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

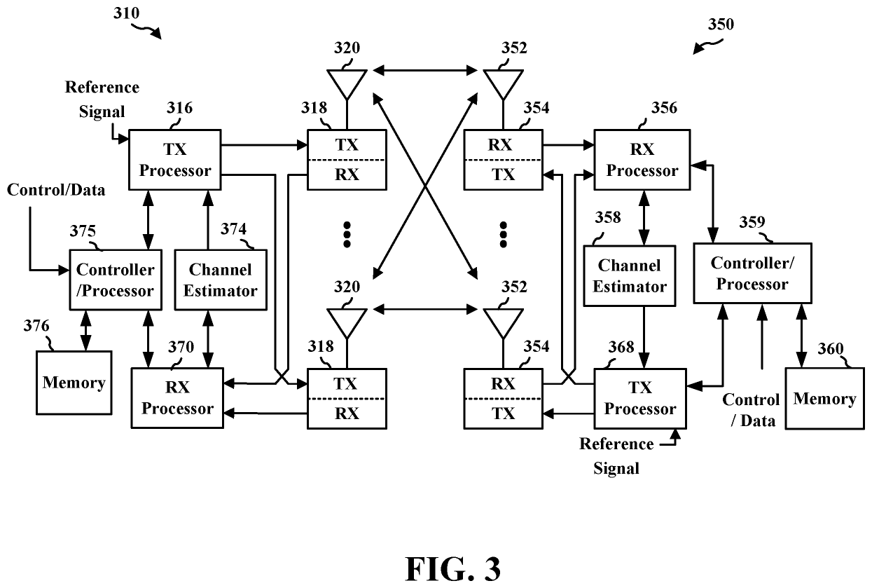

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the HARQ codebook determination component 198 of FIG. 1.

At least one of the TX processor 316, the RX processor 370, and the controller/processor 375 may be configured to perform aspects in connection with the DAI/TB counter indicator component 199 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc., that support communication with multiple users. In many cases, common protocols that facilitate communications with wireless devices are adopted in various telecommunication standards. For example, communication methods associated with eMBB, mMTC, and URLLC may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

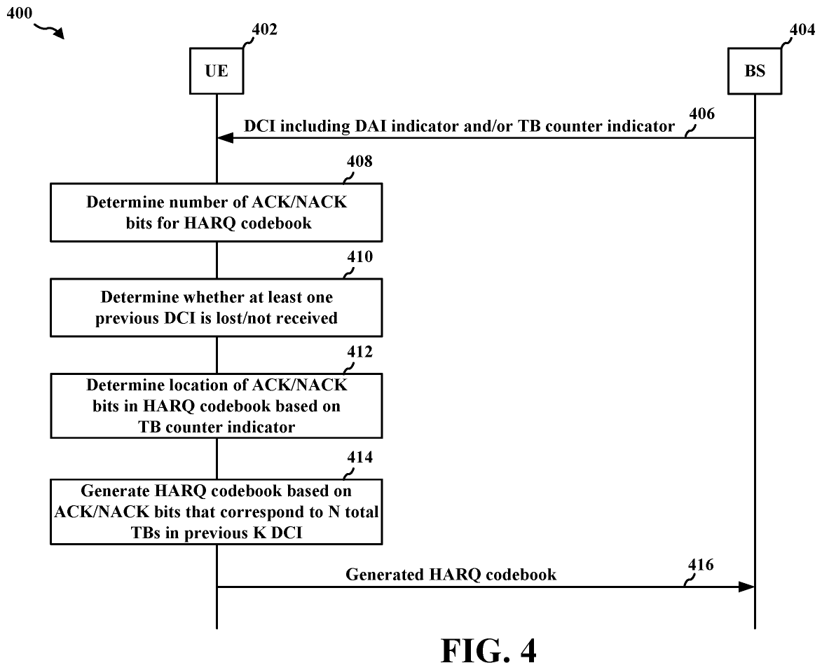

FIG. 4 is a call flow diagram 400 illustrating communications between a UE 402 and a base station 404. At 406, the base station 404 may transmit DCI including a DAI indicator and/or a TB counter indicator to the UE 402. The DAI indicator, which may be referred to as a counter DAI (CDAI), may be used by the UE 402 to count a DCI number for a particular DCI of a plurality of DCIs. The TB counter indicator may indicate a total number of P TBs in a most recent K DCIs indexed by the DAI indicator.

At 408, the UE 402 may determine a number of ACK/NACK bits for a HARQ codebook. The number of ACK/NACK bits determined, at 408, may be based on the DAI indicator and/or the TB counter indicator received, at 406, from the base station 404. The TB counter indicator may determine a number of NACK padding bits to include in the HARQ codebook for the most recent K DCIs. At 410, the UE 402 may determine whether at least one previous DCI to the DCI received, at 406, is lost/not received by the UE 402. The UE 402 may determine a number of NACK bits as the padding bits to include in the HARQ codebook for the at least one previous DCI that is not received by the UE 402 based on the indication of the TB counter indicator. Accordingly, the UE 402 may determine, at 412, a location of the ACK/NACK bits in the HARQ codebook based on the TB counter indicator.

At 414, the UE 402 may generate the HARQ codebook based on ACK/NACK bits that correspond to N total TBs in the previous K DCI. More specifically, the N total TBs may correspond to a dynamic number of TBs scheduled by the previous K DCI, rather than an RRC configured value of N indicative of a maximum number of ACK/NACK feedback bits that may be transmitted to the base station 404 in association with each DCI. At 416, the UE 402 may transmit the generated HARQ codebook to the base station 404.

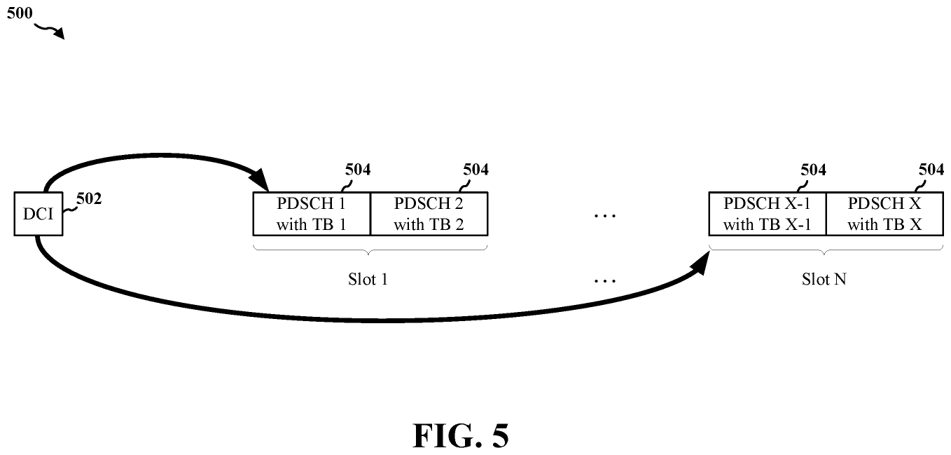

FIG. 5 is a diagram 500 illustrating a DCI 502 that schedules a plurality of TBs. A UE that receives the DCI 502 may generate a HARQ codebook for the multi-TB transmission from the base station. A single DCI may be used in lower frequency bands to schedule a PDSCH 504 for one or more TBs (e.g., 1 TB, 2 TBs, etc.). However, in higher frequency bands, such as frequency range 2× (FR2×), a single DCI 502 may be used to schedule multiple PDSCHs 504 or multiple PUSCHs with different TBs (e.g., N TBs). For the higher frequency bands that may be associated with an increased SCS, a duration of the symbols may be shorter to allow the single DCI 502 to schedule the multiple PDSCHs 504 or the multiple PUSCHs based on the different TBs. Each PDSCH/PUSCH may correspond to a TB and duration that may be maintained within a slot. Further, each TB may correspond to a HARQ process identifier (ID), a redundancy version identifier (RVID), a new data indicator (NDI), a time domain resource allocation (TDRA), a frequency domain resource allocation (FDRA), etc.

Scheduling the multiple PDSCHs 504 based on the single DL DCI 502 and/or scheduling the multiple PUSCHs based on the single UL DCI may or may not be supported for the serving cell and/or the UE. Each PDSCH/PUSCH may be associated with individual/separate TB(s), such that each PDSCH/PUSCH may be maintained within the slot. The single DCI 502 may be associated with a maximum number of PDSCHs/PUSCHs that may be scheduled via the single DCI 502. In examples, scheduling the multiple PDSCHs 504 may be performed for 120 kHz SCS in addition to 480 kHz SCS and 960 kHz SCS. In further examples, single slot scheduling via slot-based monitoring may be supported for at least 120 KHz SCS.

In a first aspect, the single DCI 502 may schedule both PDSCH 504 and a PUSCH. In a second aspect, the single DCI 502 may schedule one or more TBs, where a single TB may be mapped over multiple slots, and where the mapping may not be performed based on repetition. In a third aspect, the single DCI 502 may schedule N TBs, where N>1, and where a TB nay be repeated over multiple slots or multiple mini-slots. Slot aggregation and/or repetition for PDSCH/PUSCH by the single DCI 502 may not be precluded in such cases for the serving cell.

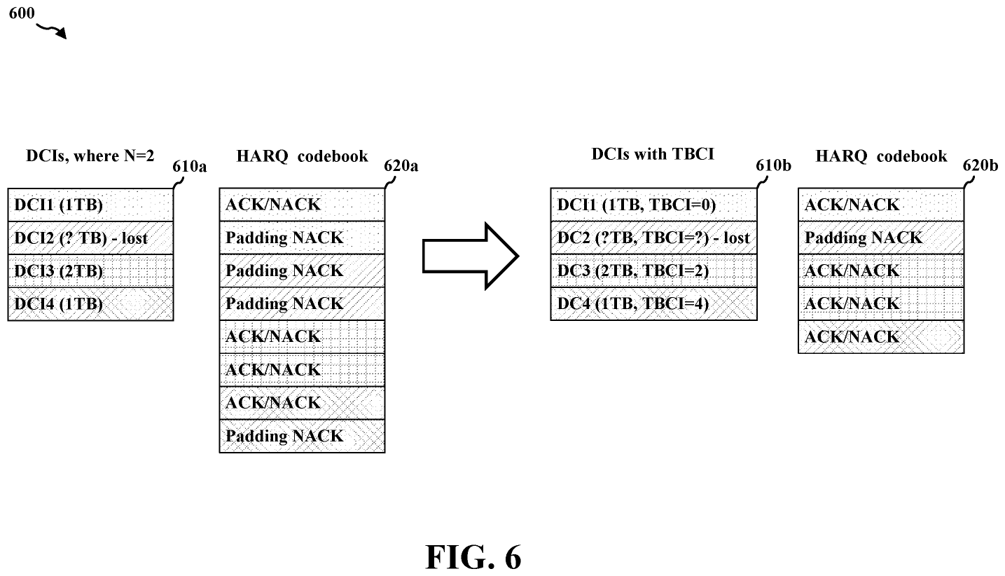

FIG. 6 is a diagram 600 illustrating HARQ codebook tables 620a-620b that are generated based on DCI tables 610a-610b. If a single DCI is configured to schedule up to N TBs or code block groups (CBGs) (e.g., N=2 bits), the UE may feedback N bits of ACK/NACK in UCI for each DCI of the HARQ codebook. Although each DCI may be configured to schedule up to N TBs or CBGs, a particular DCI of the DCIs may not schedule N TBs or CBGs. For example, some DCIs, such as DCI1 and DCI4 in the DCI table 610a, may schedule less than N TBs or CBGs (e.g., 1 TB). Regardless of the number of TBs or CBGs scheduled by particular DCIs, the UE may be configured to feedback N total bits of ACK/NACK (e.g., N=2) for each DCI, even if some of the DCIs schedule less than N bits. For instance, if N=2 and a particular DCI schedules 1 TB, the UE may feedback an ACK/NACK bit for the one TB and a padding NACK bit for a non-scheduled second TB of the DCI. If a DCI, such as DCI2 in the DCI table 610a, is lost/not received, the UE may feedback 2 padding NACK bits corresponding to a maximum number of ACK/NACK feedback bits (e.g., N=2 bits) to be transmitted to the base station for each DCI.

The UE may utilize a counter/field to determine that DCI2 in the DCI table 610a is lost/not received. For example, if the UE receives a first DCI (e.g., DCI1) corresponding to counter value 1 and a subsequent DCI (e.g., DCI3) corresponding to counter value 3, the UE may determine that an intermediate DCI (e.g., DCI2) is lost based on not receiving the intermediate DCI indicative of counter value 2. In some aspects, the UE may determine whether a particular DCI is lost based on both the DAI value of the counter DAI and the total DAI. While the UE may be configured to determine that the intermediate DCI is lost based on counter values, the UE may be unable to determine a number of TBs that are scheduled via the lost DCI(s). For example, if each of the DCIs are configured to schedule up to 2 TBs, the UE may be unable to determine whether a lost DCI scheduled 1 TB or 2 TBs.

For received DCIs that schedule n<N TBs, the UE may feedback a first n bits of ACK/NACK for the scheduled TB(s), and may feedback/transmit padding NACK padding bit(s) in UCI for a remaining number of N−n feedback bits to provide a total number of ACK/NACK bits that correspond to a maximum number of TBs that may be scheduled in a single DCI. The maximum number of TBs N may be based on an RRC configuration. Thus, the HARQ codebook associated with the HARQ codebook table 620a may be scaled in size based on the value of N.

If each of the DCIs are configured to schedule up to 2 TBs, the first 2 bits in the HARQ codebook may correspond to the first DCI, even if the first DCI schedules solely 1 TB. For example, if the UE receives DCI1 and determines that DCI1 schedules 1 TB, the UE may generate 1 bit of ACK/NACK for DCI1 and generate/transmit 1 padding NACK bit for a second TB that was not scheduled via DCI1. If the UE determines that DCI2 is lost, the UE may generate and transmit 2 padding NACK bits to the base station based on N=2, regardless of whether the lost DCI2 scheduled 1 TB or 2 TBs. If the UE receives DCI3 and determines that DCI3 schedules 2 TBs, the UE may generate and transmit respective ACK/NACK bits based on respective decoding results associated with each of the 2 TBs. That is, the UE may generate 2 ACKs, 2 NACKs, 1 ACK followed by 1 NACK, or 1 NACK followed by 1 ACK. If DCI4 is subsequently determined to schedule solely 1 TB, the UE may again generate feedback in a similar manner to the feedback generated for DCI1. That is, the UE may generate 1 bit of ACK/NACK for the 1 TB of DCI4 and 1 padding NACK for the second TB that is not scheduled via DCI4. The UE may set the bit as ACK or NACK for a scheduled TB or CBG based on a decoding result.

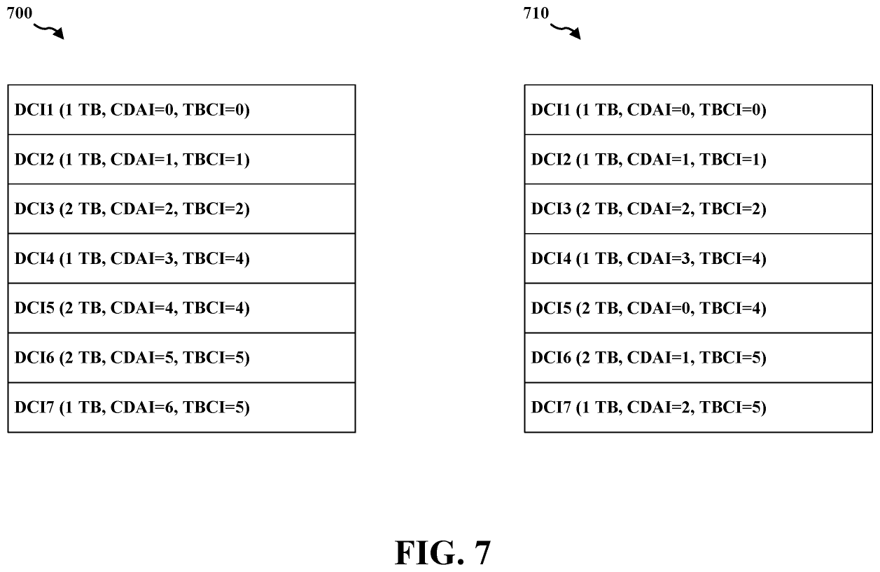

A single DCI may be configured to schedule multiples TBs based on spatial division multiplexing (SDM). Overhead associated with the padding NACKs, when generated/transmitted in association with 1 TB or 2 TBs, may not have a significant impact on performance. However, the overhead may be increased when a single DCI is configured to schedule an increased number of TBs (e.g., via time division multiplexing (TDM)), as the HARQ codebook associated with the HARQ codebook table 620a may scaled in size based on an increasing value of N. Hence, a large value of N may provide a large HARQ codebook size when the UE transmits N bits of ACK/NACK for each DCI. Referring to the HARQ codebook table 620b associated with the DCI table 610b, overhead may be reduced and performance may be improved based on the UE solely transmitting ACK/NACK bits for TBs that are actually scheduled by the DCIs and solely transmitting padding NACKs when a DCI is lost. FIG. 7 illustrates tables 700-710 indicative of HARQ codebooks configured in association with multi-TB transmissions. A HARQ codebook configuration based on the tables 700-710 may reduce a size of the HARQ codebook for DCI that may schedule up to N TBs. In a first aspect, a UE configured with multi-TB reception for a single DCI may determine a DAI indicator and a TB counter indicator from the DCI. The DAI indicator may be referred to as a CDAI indicator and may be used by the UE to count a DCI number for determining when one or more DCIs are lost. The TB counter indicator may indicate a total number of P TBs in a most recent K DCIs indexed by the DAI indicator. For example, if a counter for the DAI indicator corresponds to n bits (e.g., n=2), then K=2ⁿ−1. In further aspects, the TB counter indicator may indicate a total number of P TBs in a most recent K DCIs up to and including the current DCI indexed by the DAI indicator, such that K=2ⁿ. The TB counter indicator may indicate a number of NACK bits to be padded if one or more of the previous DCIs are lost, where the lost DCI(s) may be determined based on the DAI indicator. That is, when n=2, based on DAI values in the DCI, the UE may determine that a number of DCIs, e.g., 1 DCI, 2 DCIs, or 3 DCIs, are lost prior to a currently received DCI. Hence, the TB counter indicator may indicate the number of NACK bits to be padded.

In examples, the UE may receive 7 DCIs that correspond to a first DCI through a seventh DCI, where one or more of the 7 DCIs may be lost. Each DCI may include a DAI/CDAI indicator field, which may be associated with a corresponding number (e.g., a count number, as illustrated in the table 700, or a modular number, as illustrated in the table 710). The first DCI/DCI1 may correspond to CDAI=0, the second DCI/DCI2 may correspond to CDAI=1, etc., up to CDAI=6 for the seventh DCI/DCI7 in the tables 700-710. If the UE detects DCI1 and DCI3 based on the CDAI values, but the UE does not detect DCI2 based on a CDAI value, the UE may determine that DCI2 is lost.

The CDAI value in the table 710 may be indicated as a modular number. For example, if the UE is configured based on 2 bits, the CDAI values may correspond to CDAI=0, CDAI=1, CDAI=2, and CDAI=3 for DCI1-DCI4, and may again cycle through the CDAI values corresponding to CDAI=0, CDAI=1, and CDAI=2 for DCI5-DCI7. For a single DCI that may schedule up to N TBs, the TB count indicator may be used to determine the number of TBs that are scheduled in the most recent K DCIs. Thus, K may be associated with the counter. If the counter for the DAI includes 2 bits, then K=3 based on K=2ⁿ−1. In order to reduce a size of the TB counter indicator, the total number of P TBs may correspond to P=p*T, where p may be a configured value (e.g., associated with a modular number, such as p=3) and T may be indicative of a TB counter indicator value. For instance, p may correspond to a unit value (e.g., other than 1), where the number of TBs may be counted in a unit of p. In other examples, P may be based on T=P−K when each DCI includes more than 1 TB.

In the tables 700-710, DCI1 may schedule 1 TB and may correspond to TB counter indicator (TBCI)=0, since no prior DCIs schedule other TBs before DCI1. Although the zero value for the TBCI is used as an example, the DCI1 may have a non-zero value for the TBCI that counts for the scheduled TBs prior to DCI1. Although TBCI=0 is used as example, the TBCI may be any value based on the accumulated number of TBs in the previous DCIs. For DCI2, CDAI=1 and TBCI=1 based on 1 TB being scheduled in the previous K=3 DCIs. More specifically, there is solely 1 DCI to analyze in the tables 700-710 prior to DCI2, and that DCI (e.g., DCI1) schedules 1 TB that provides TBCI=1. For DCI3, 2 TBs are scheduled, CDAI=2, and TBCI=2 based on the total number of TBs scheduled by DCI1 and DCI2 being equal to 2. For DCI4, 1 TB is scheduled, CDAI=3, and TBCI=4, based on the total number of TBs scheduled by the previous K=3 DCI (e.g., DCI1-DCI3) being equal to 4 (e.g., 1 TB for DCI1, 1 TB for DCI2, and 2 TBs for DCI3). For DCI5, TBCI=4 since the previous K=3 DCI corresponds to DCI2-DCI4. That is, the 1 TB scheduled by DCI1 is not indicated via the TBCI for DCI5. Rather than counting the TBs per DCI, the TBs may be counter per fixed number of previous DCI to reduce the size of the HARQ codebook via reducing the number of padding NACKs indicated for lost/non-received DCI bits.

In a second aspect where the UE is configured with multi-TB reception for a single DCI based on the DAI indicator and the TB counter indicator determined from the DCI, the UE may pad the number of NACK bits in the HARQ codebook for the lost DCIs based on a value of the TB counter indicator. If the DCI indicates that the TB counter indicator value is equal to P (e.g., the total number of TBs in the last K DCI), the UE may generate a number of P bits in the HARQ codebook for the previous 3DCIs indexed via the CDAI. The value of 3 may be determined based on the CDAI value. If the UE receives DCI1 and schedules P1 TBs, or receives DCI2 and schedules P2 TBs, or receives DCI3 and schedules P3 TBs, the UE may generate P1, or P2, or P3 ACK/NACK bits in accordance with the received DCI. When the UE decodes each received DCI, the UE may generate an exact number of bits that corresponds to the TBs scheduled in the received DCIs. The UE may determine the locations of the ACK/NACK bits in the HARQ codebook based on the TB counter indicator. As such, the HARQ codebook may be dynamically padded with NACK bits, rather than being scaled based on an RRC configured value of N.

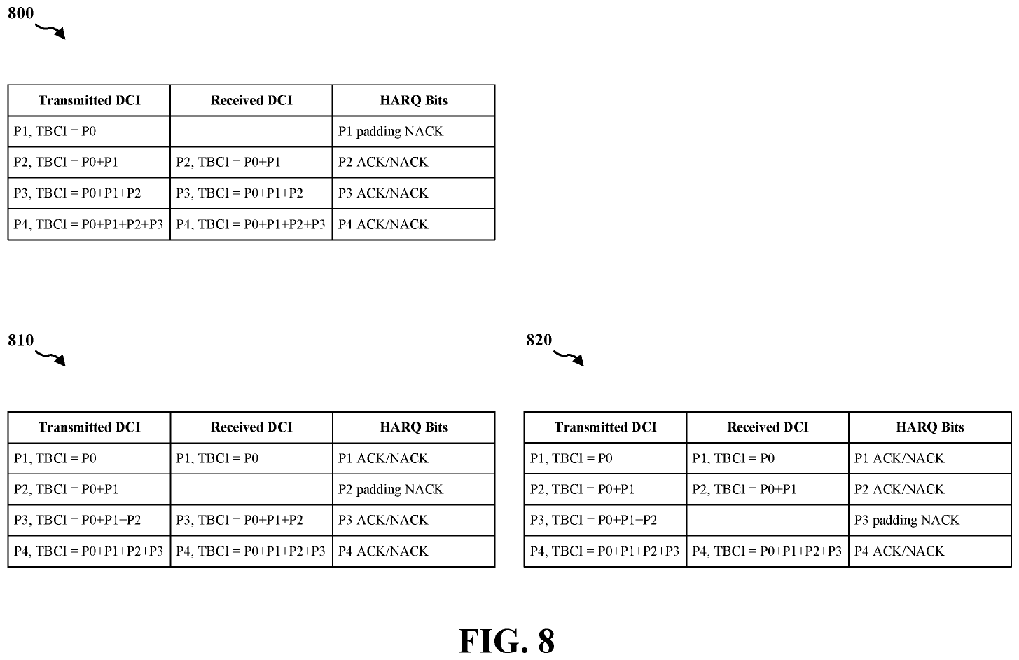

FIG. 8 illustrates tables 800-820 indicative of HARQ codebook generation procedures associated with a lost DCI in the previous K=3 DCI. The tables 800-820 include a plurality of parameters for transmitted DCI, received DCI, and HARQ bits. DCI1 may include P1 TBs and correspond to TBCI=P0, DCI2 may include P2 TBs and correspond to TBCI=P0+P1, DCI3 may include P3 TBs and correspond to TBCI=P0+P1+P2, and DCI4 may include P4 TBs and correspond to TBCI=P0+P1+P2+P3. The values of the TBCIs may correspond to the TB counter indicator field set by the base station for the different DCI.

The lost DCI in the tables 800-820 may be determined based on a missing parameter associated with the received DCIs in the tables 800-820. For example, the UE may determine based on the table 800 that DCI1 is lost, but that DCI2-DCI4 is received; the UE may determine based on the table 810 that DCI 2 is lost, but that DCI1 and DCI3-DCI4 is received; or the UE may determine based on the table 820 that DCI3 is lost, but that DCI1-DCI2 and DCI4 is received. Referring to the table 800, the UE may generate P1 padding NACKs after the UE determines that P2 is scheduled/received via DCI2 based on TBCI=P0+P1, but that P1 has not been received. Without loss of generality, P0 may be determined by the UE based on decoding of DCIs prior to DCI1. Since the UE may be unable to determine the number of scheduled TBs for the lost DCI, the UE may determine the number of P1 padding NACK bits in the HARQ codebook based on TBCI=P0+P1 determined from DCI2, where the values of the TBCIs and P0 are determinable by the UE.

Referring still to the table 800, for DCI2-DCI4, the UE may generate a corresponding number of ACK/NACK bits based on DCI2-DCI4 being received. That is, if the UE receives DCI2-DCI4, the UE may generate P2 bits of ACK/NACK for the scheduled TBs of DCI2, P3 bits of ACK/NACK for the scheduled TBs of DCI3, and P4 bits of ACK/NACK for the scheduled TBs of DCI4. Table 810 is associated with a similar procedure, based on DCI 2 being lost. Table 820 is likewise associated with the similar procedure, based on DCI3 being lost. The UE may be configured to determine the TB counter indicator value both before and after an intermediate DCI is lost to determine that the intermediate DCI is lost.

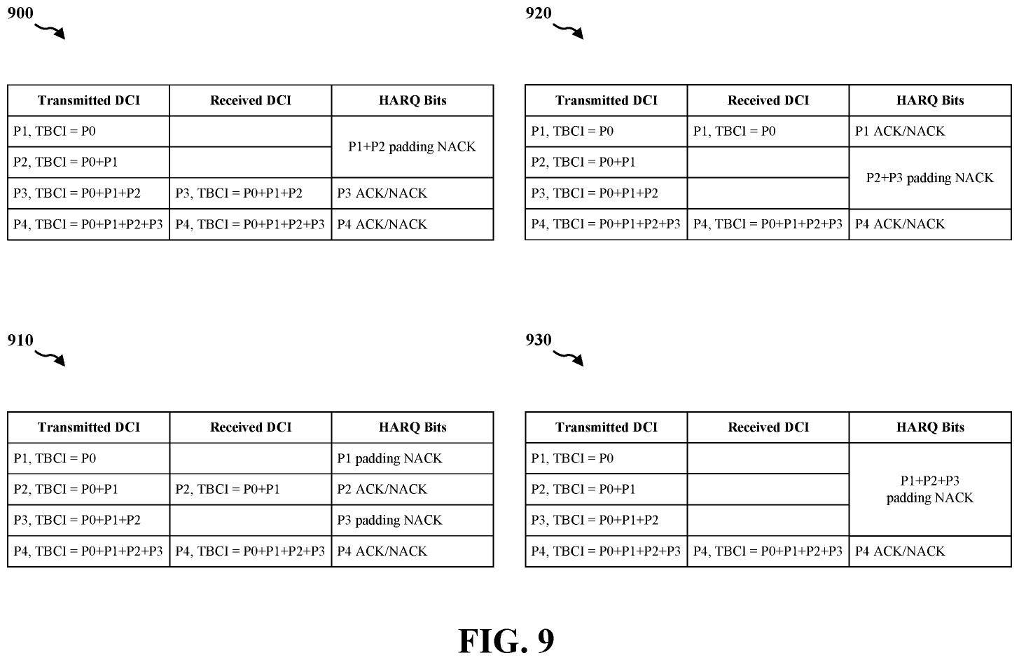

FIG. 9 illustrates tables 900-930 indicative of HARQ codebook generation procedures associated with a plurality of lost DCIs in the previous K=3 DCIs. The tables 900-930 include a plurality of parameters for transmitted DCI, received DCI, and HARQ bits. DCI1 may include P1 TBs and correspond to TBCI=P0, DCI2 may include P2 TBs and correspond to TBCI=P0+P1, DCI3 may include P3 TBs and correspond to TBCI=P0+P1+P2, and DCI4 may include P4 TBs and correspond to TBCI=P0+P1+P2+P3. The values of the TBCIs may correspond to the TB counter indicator field set by the base station for the different DCI.

The lost DCI in the tables 900-930 may be determined based on missing parameters associated with the received DCI in the tables 900-930. For example, the UE may determine based on the table 900 that DCI1-DCI2 is lost, but that DCI3-DCI4 is received; the UE may determine based on the table 910 that DCI1 and DCI3 is lost, but that DCI2 and DCI4 is received; the UE may determine based on the table 920 that DCI2-DCI3 is lost, but that DCI1 and DCI4 is received; or the UE may determine based on the table 930 that DCI1-DCI3 is lost, but that DCI 4 is received. In examples, the UE may be unable to detect four consecutive lost DCIs based on the DAI indicator (e.g., when K=3 is set for the UE and predetermined by the UE).

Referring to table 900, the UE may determine based on receiving DCI3 that a total number of missing/lost TBs is equal to P1+P2, which may indicate to the UE that both DCI1 and DCI2 are lost. While the UE may be able to determine the total number of lost P1+P2 TBs scheduled by DCI1 and DCI2, the UE may be unable to determine the number of TBs individually/respectively scheduled by each of the lost DCIs. However, since the value of P0 may be predetermined by the UE, the UE may generate P1+P2 padding NACK bits for the total number of lost DCIs. The UE may subsequently transmit ACK/NACK bits for DCI3-DCI4 based on DCI3-DCI4 being received by the UE. Table 920 similarly illustrates two consecutively lost DCIs (e.g., DCI2-DCI3) and may be associated with a similar NACK padding procedure to the NACK padding procedure of table 900. Table 910 illustrates two non-consecutive lost DCIs (e.g., lost DCI1 and lost DCI3), where NACK padding may be performed twice based on repeating a NACK padding procedure (e.g., similar to the NACK padding procedures of tables 800-820).

Referring to table 930, the UE may determine, after receiving DCI4, that three DCIs are lost (e.g., DCI1, DCI2, and DCI3) based on a TB delta that corresponds to P1+P2+P3. Thus, the UE may generate P1+P2+P3 padding NACK bits, even though the UE may be unable to determine the number of TBs individually/respectively scheduled by each of the lost DCIs. Accordingly, the UE may generate the HARQ codebook based on dynamically padded NACK bits, rather than scaling the HARQ codebook based on an RRC configured value of N. In some examples, the UE may be unable to determine that DCI4 is lost when a subsequent DCI is not received by the UE to indicate that DCI4 is lost.

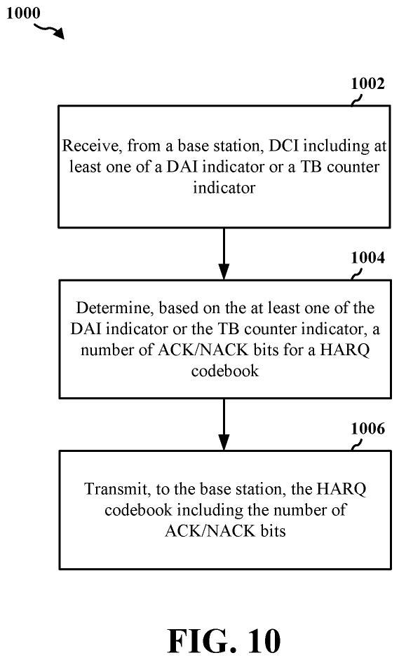

FIG. 10 is a flowchart 1000 of a method of wireless communication. The method may be performed by a UE (e.g., the UE 104/402; the apparatus 1302; etc.), which may include the memory 360 and which may be the entire UE 104/402 or a component of the UE 104/402, such as the TX processor 368, the RX processor 356, and/or the controller/processor 359.

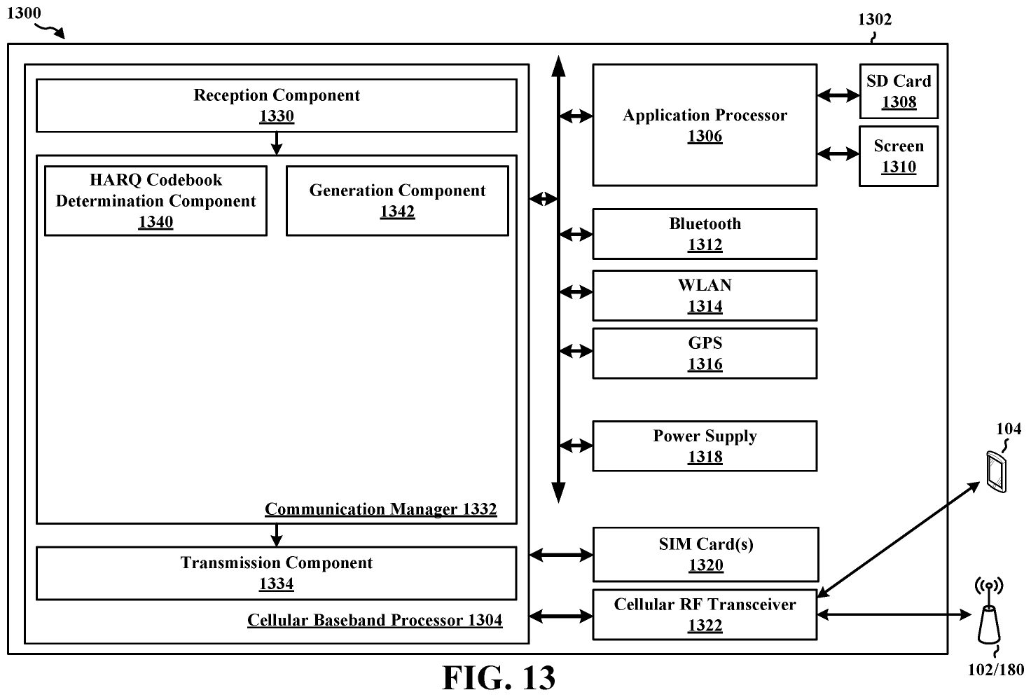

At 1002, the UE may receive, from a base station, DCI including at least one of a DAI indicator or a TB counter indicator. For example, referring to FIG. 4, the UE 402 may receive, at 406, DCI including a DAI indicator and/or a TB counter indicator from the base station 404. The reception, at 1002, may be performed by the HARQ codebook determination component 198/1340 in FIGS. 1 and 13.

At 1004, the UE may determine, based on the at least one of the DAI indicator or the TB counter indicator, a number of ACK/NACK bits for a HARQ codebook. For example, referring to FIGS. 4 and 8-9, the UE 402 may determine, at 408, a number of ACK/NACK bits for the HARQ codebook. For instance, the number of ACK/NACK bits for the HARQ codebook may correspond to the HARQ bits of tables 800-820 and tables 900-930. The determination, at 1004, may be performed by the HARQ codebook determination component 198/1340 in FIGS. 1 and 13.

At 1006, the UE may transmit, to the base station, the HARQ codebook including the number of ACK/NACK bits. For example, referring to FIG. 4, the UE 402 may transmit, at 416, the generated HARQ codebook to the base station 404. The transmission, at 1006, may be performed by the HARQ codebook determination component 198/1340 in FIGS. 1 and 13.

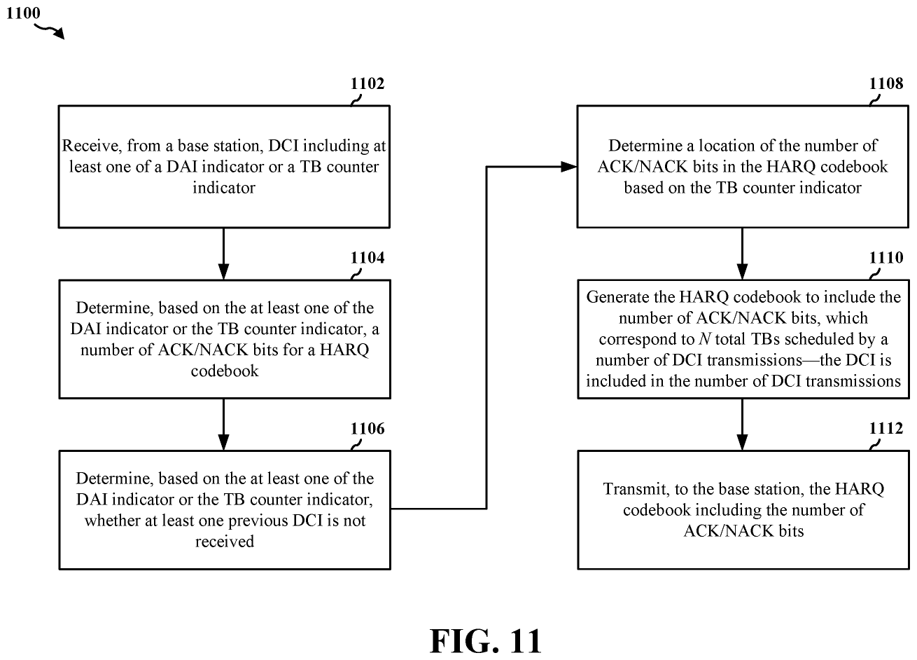

FIG. 11 is a flowchart 1100 of a method of wireless communication. The method may be performed by a UE (e.g., the UE 104/402; the apparatus 1302; etc.), which may include the memory 360 and which may be the entire UE 104/402 or a component of the UE 104/402, such as the TX processor 368, the RX processor 356, and/or the controller/processor 359.

At 1102, the UE may receive, from a base station, DCI including at least one of a DAI indicator or a TB counter indicator. For example, referring to FIGS. 4 and 7, the UE 402 may receive, at 406, DCI including a DAI indicator and/or a TB counter indicator from the base station 404. The TB counter indicator included in the reception, at 406, may indicate a total number of P TBs in a most recent number of K previous DCI, where the K previous DCI may be indexed based on the DAI indicator (e.g., as illustrated in the tables 700-710). When the DAI indicator includes n bits, K may be equal to 2ⁿ⁻¹. The reception, at 1102, may be performed by the HARQ codebook determination component 198/1340 in FIGS. 1 and 13.

At 1104, the UE may determine, based on the at least one of the DAI indicator or the TB counter indicator, a number of ACK/NACK bits for a HARQ codebook. For example, referring to FIGS. 4 and 7-9, the UE 402 may determine, at 408, a number of ACK/NACK bits for the HARQ codebook. For instance, the number of ACK/NACK bits for the HARQ codebook may correspond to the HARQ bits of tables 800-820 and tables 900-930. A number of P bits for the HARQ codebook may correspond to P=p*T, where T is a value of the TB counter indicator and p is a configured value associated with a modular number, such as modular number as illustrated in the table 710. A value T for the TB counter indicator may correspond to T=P−K, where P indicates a number of bits for the HARQ codebook and K indicates a number of most recent previous DCI indexed based on the DAI indicator. The determination, at 1104, may be performed by the HARQ codebook determination component 198/1340 in FIGS. 1 and 13.

At 1106, the UE may determine, based on the at least one of the DAI indicator or the TB counter indicator, whether at least one previous DCI is not received. For example, referring to FIGS. 4, 6, and 8-9, the UE 402 may determine, at 410, whether at least one previous DCI is lost/not received. The diagram 600, the tables 800-820, and the tables 900-930 are also indicative of DCI that is lost/not received. The number of ACK/NACK bits for the HARQ codebook may include one or more NACK bits, as illustrated in the tables 800-820 and the tables 900-930, that correspond to one or more TBs of the at least one previous DCI when the at least one previous DCI is not received. The at least one previous DCI that is not received may include at least one of consecutive DCI that is not received (e.g., illustrated in the tables 900 and 920-930) or non-consecutive DCI that is not received (e.g., illustrated in the table 910). The TB counter indicator (e.g., illustrated in the tables 800-820 and the tables 900-930) may indicate a number of the one or more NACK bits to include in the HARQ codebook for the at least one previous DCI that is not received. The determination, at 1106, may be performed by the HARQ codebook determination component 198/1340 in FIGS. 1 and 13.

At 1108, the UE may determine a location of the number of ACK/NACK bits in the HARQ codebook based on the TB counter indicator. For example, referring to FIG. 4, the UE 402 may determine, at 412, the location of ACK/NACK bits in the HARQ codebook based on the TB counter indicator. The determination, at 1108, may be performed by the HARQ codebook determination component 198/1340 in FIGS. 1 and 13.

At 1110, the UE may generate the HARQ codebook to include the number of ACK/NACK bits, which correspond to N total TBs scheduled by a number of DCI transmissions-the DCI is included in the number of DCI transmissions. For example, referring to FIG. 4, the UE 402 may generate, at 414, the HARQ codebook based on ACK/NACK bits that correspond to N total TBs in the previous K DCI. The generation, at 1110, may be performed by the generation component 1342 in FIG. 13.

At 1112, the UE may transmit, to the base station, the HARQ codebook including the number of ACK/NACK bits. For example, referring to FIG. 4, the UE 402 may transmit, at 416, the generated HARQ codebook to the base station 404. The transmission, at 1112, may be performed by the HARQ codebook determination component 198/1340 in FIGS. 1 and 13.

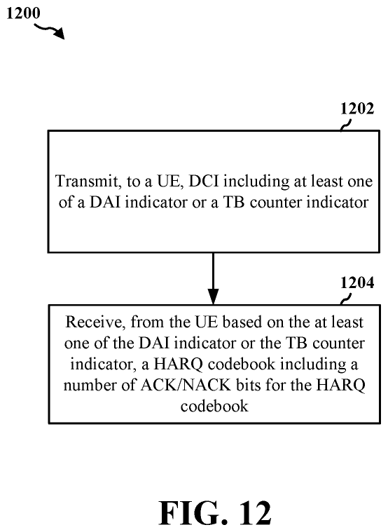

FIG. 12 is a flowchart 1200 of a method of wireless communication. The method may be performed by a base station (e.g., the base station 102/404; the apparatus 1402; etc.), which may include the memory 376 and which may be the entire base station 102/404 or a component of the base station 102/404, such as the TX processor 316, the RX processor 370, and/or the controller/processor 375.

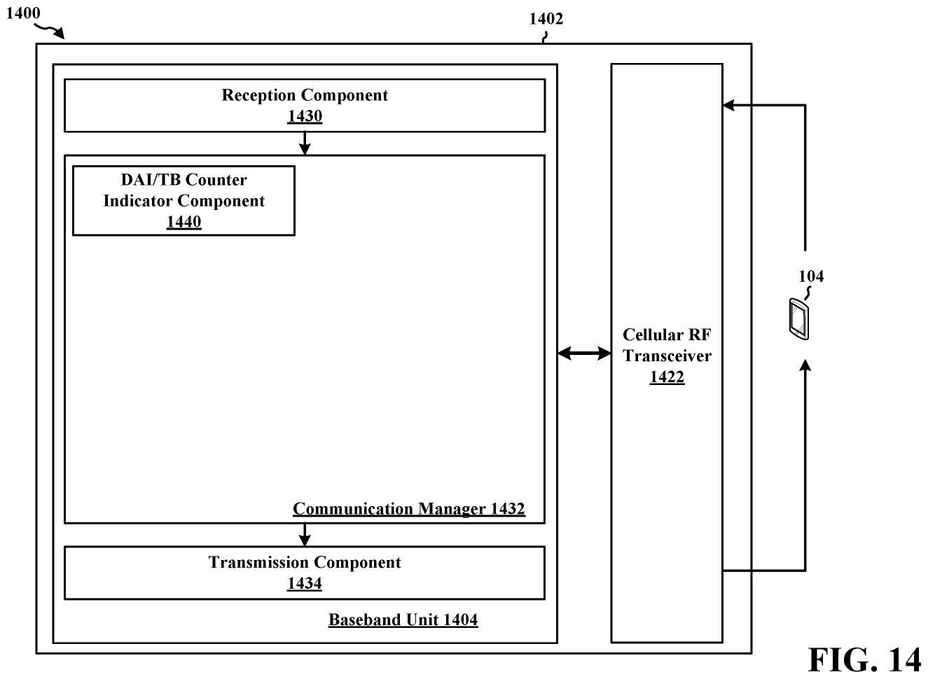

At 1202, the base station may transmit, to a UE, DCI including at least one of a DAI indicator or a TB counter indicator. For example, referring to FIG. 4, the base station may transmit, at 406, DCI including a DAI indicator and/or a TB counter indicator to the UE 402. The transmission, at 1202, may be performed by the DAI/TB counter indicator component 199/1440 in FIGS. 1 and 14.

At 1204, the base station may receive, from the UE based on the at least one of the DAI indicator or the TB counter indicator, a HARQ codebook including a number of ACK/NACK bits for the HARQ codebook. For example, referring to FIG. 4, the base station may receive, at 416, the generated HARQ codebook from the UE 402. The reception, at 1204, may be performed by the DAI/TB counter indicator component 199/1440 in FIGS. 1 and 14.

FIG. 13 is a diagram 1300 illustrating an example of a hardware implementation for an apparatus 1302. The apparatus 1302 may be a UE, a component of a UE, or may implement UE functionality. In some aspects, the apparatus 1302 may include a cellular baseband processor 1304 (also referred to as a modem) coupled to a cellular RF transceiver 1322. In some aspects, the apparatus 1302 may further include one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, or a power supply 1318. The cellular baseband processor 1304 communicates through the cellular RF transceiver 1322 with the UE 104 and/or BS 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304. The cellular baseband processor 1304 may be a component of the UE 350 and may include the memory 360 and/or at least one of the TX processor 368, the RX processor 356, and the controller/processor 359. In one configuration, the apparatus 1302 may be a modem chip and include just the baseband processor 1304, and in another configuration, the apparatus 1302 may be the entire UE (e.g., see 350 of FIG. 3) and include the additional modules of the apparatus 1302. The communication manager 1332 includes a HARQ codebook determination component 1340 that is configured, e.g., as described in connection with 1002, 1004, 1006, 1102, 1104, 1106, 1108, and 1112, to receive, from a base station, DCI including at least one of a DAI indicator or a TB counter indicator; to determine, based on the at least one of the DAI indicator or the TB counter indicator, a number of ACK/NACK bits for a HARQ codebook; to determine, based on the at least one of the DAI indicator or the TB counter indicator, whether at least one previous DCI is not received; to determine a location of the number of ACK/NACK bits in the HARQ codebook based on the TB counter indicator; and to transmit, to the base station, the HARQ codebook including the number of ACK/NACK bits. The communication manager 1332 further includes a generation component 1342 that is configured, e.g., as described in connection with 1110, to generate the HARQ codebook to include the number of ACK/NACK bits, which correspond to N total TBs scheduled by a number of DCI transmissions—the DCI is included in the number of DCI transmissions.

The apparatus may include additional components that perform each of the blocks of the algorithm in the flowcharts of FIGS. 10-11. As such, each block in the flowcharts of FIGS. 10-11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the cellular baseband processor 1304, includes means for receiving, from a base station, DCI including at least one of a DAI indicator or a TB counter indicator; means for determining, based on the at least one of the DAI indicator or the TB counter indicator, a number of ACK/NACK bits for a HARQ codebook; and means for transmitting, to the base station, the HARQ codebook including the number of ACK/NACK bits. The apparatus 1302 further includes means for determining, based on the at least one of the DAI indicator or the TB counter indicator, whether at least one previous DCI is not received. The apparatus 1302 further includes means for determining a location of the number of ACK/NACK bits in the HARQ codebook based on the TB counter indicator. The apparatus 1302 further includes means for generating the HARQ codebook to include the number of ACK/NACK bits, the number of ACK/NACK bits corresponding to N total TBs scheduled by a number of DCI transmissions, the DCI included in the number of DCI transmissions.

The means may be one or more of the components of the apparatus 1302 configured to perform the functions recited by the means. As described supra, the apparatus 1302 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 14 is a diagram 1400 illustrating an example of a hardware implementation for an apparatus 1402. The apparatus 1402 may be a base station, a component of a base station, or may implement base station functionality. In some aspects, the apparatus 1302 may include a baseband unit 1404. The baseband unit 1404 may communicate through a cellular RF transceiver 1422 with the UE 104. The baseband unit 1404 may include a computer-readable medium/memory. The baseband unit 1404 is responsible for general processing, including the execution of software stored on the computer-readable medium/memory. The software, when executed by the baseband unit 1404, causes the baseband unit 1404 to perform the various functions described supra. The computer-readable medium/memory may also be used for storing data that is manipulated by the baseband unit 1404 when executing software. The baseband unit 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the baseband unit 1404. The baseband unit 1404 may be a component of the base station 310 and may include the memory 376 and/or at least one of the TX processor 316, the RX processor 370, and the controller/processor 375.

The communication manager 1432 includes a DAI/TB counter indicator component 1440 that is configured, e.g., as described in connection with 1202 and 1204, to transmit, to a UE, DCI including at least one of a DAI indicator or a TB counter indicator; and to receive, from the UE based on the at least one of the DAI indicator or the TB counter indicator, a HARQ codebook including a number of ACK/NACK bits for the HARQ codebook.

The apparatus may include additional components that perform each of the blocks of the algorithm in the flowchart of FIG. 12. As such, each block in the flowchart of FIG. 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the baseband unit 1404, includes means for transmitting, to a UE, DCI including at least one of a DAI indicator or a TB counter indicator; and means for receiving, from the UE based on the at least one of the DAI indicator or the TB counter indicator, a HARQ codebook including a number of ACK/NACK bits for the HARQ codebook.

The means may be one or more of the components of the apparatus 1402 configured to perform the functions recited by the means. As described supra, the apparatus 1402 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.
Aspect 1 is an apparatus for wireless communication at a UE including at least one processor coupled to a memory and configured to receive, from a base station, DCI including at least one of a DAI indicator or a TB counter indicator; determine, based on the at least one of the DAI indicator or the TB counter indicator, a number of ACK/NACK bits for a HARQ codebook; and transmit, to the base station, the HARQ codebook including the number of ACK/NACK bits.
Aspect 2 may be combined with aspect 1 and includes that the at least one processor is further configured to determine, based on the at least one of the DAI indicator or the TB counter indicator, whether at least one previous DCI is not received.
Aspect 3 may be combined with any of aspects 1-2 and includes that the number of ACK/NACK bits includes one or more NACK bits that correspond to one or more TBs of the at least one previous DCI when the at least one previous DCI is not received.
Aspect 4 may be combined with any of aspects 1-3 and includes that the at least one previous DCI that is not received includes at least one of consecutive DCI that is not received or non-consecutive DCI that is not received.
Aspect 5 may be combined with any of aspects 1-4 and includes that the TB counter indicator indicates a number of the one or more NACK bits to include in the HARQ codebook for the at least one previous DCI that is not received.
Aspect 6 may be combined with any of aspects 1-5 and includes that the TB counter indicator indicates a total number of P TBs in a most recent number of K previous DCI, the K previous DCI indexed based on the DAI indicator.
Aspect 7 may be combined with any of aspects 1-6 and includes that K=2ⁿ⁻¹ when the DAI indicator includes n bits.
Aspect 8 may be combined with any of aspects 1-7 and includes that a number of P bits for the HARQ codebook corresponds to P=p*T, where T is a value of the TB counter indicator and p is a configured value associated with a modular number.
Aspect 9 may be combined with any of aspects 1-8 and includes that a value T of the TB counter indicator corresponds to T=P−K, where P indicates a number of bits for the HARQ codebook and K indicates a number of most recent previous DCI indexed based on the DAI indicator.
Aspect 10 may be combined with any of aspects 1-9 and includes that the at least one processor is further configured to determine a location of the number of ACK/NACK bits in the HARQ codebook based on the TB counter indicator.
Aspect 11 may be combined with any of aspects 1-10 and includes that the at least one processor is further configured to generate the HARQ codebook to include the number of ACK/NACK bits, the number of ACK/NACK bits corresponding to N total TBs scheduled by a number of DCI transmissions, the DCI included in the number of DCI transmissions.
Aspect 12 may be combined with any of aspects 1-11 and further includes a transceiver coupled to the at least one processor.
Aspect 13 is an apparatus for wireless communication at a base station including at least one processor coupled to a memory and configured to transmit, to a UE, DCI including at least one of a DAI indicator or a TB counter indicator; and receive, from the UE based on the at least one of the DAI indicator or the TB counter indicator, a HARQ codebook including a number of ACK/NACK bits for the HARQ codebook.
Aspect 14 may be combined with aspect 13 and includes that the number of ACK/NACK bits includes one or more NACK bits that correspond to one or more TBs of at least one previous DCI that is not received from the base station.
Aspect 15 may be combined with any of aspects 13-14 and includes that the at least one previous DCI that is not received from the base station includes at least one of consecutive DCI that is not received from the base station or non-consecutive DCI that is not received from the base station.
Aspect 16 may be combined with any of aspects 13-15 and includes that the TB counter indicator indicates a number of the one or more NACK bits to include in the HARQ codebook for the at least one previous DCI that is not received from the base station.
Aspect 17 may be combined with any of aspects 13-16 and includes that the TB counter indicator indicates a total number of P TBs in a most recent number of K previous DCI, the K previous DCI indexed based on the DAI indicator.
Aspect 18 may be combined with any of aspects 13-17 and includes that K=2ⁿ⁻¹ when the DAI indicator includes n bits.
Aspect 19 may be combined with any of aspects 13-18 and includes that a number of P bits for the HARQ codebook corresponds to P=p*T, where Tis a value of the TB counter indicator and p is a configured value associated with a modular number.
Aspect 20 may be combined with any of aspects 13-19 and includes that a value T of the TB counter indicator corresponds to T−P−K, where P indicates a number of bits for the HARQ codebook and K indicates a number of most recent previous DCI indexed based on the DAI indicator.
Aspect 21 may be combined with any of aspects 13-20 and includes that the number of ACK/NACK bits corresponds to N total TBs scheduled by a number of DCI transmissions, the DCI included in the number of DCI transmissions.
Aspect 22 may be combined with any of aspects 13-21 and further includes a transceiver coupled to the at least one processor.
Aspect 23 is a method of wireless communication for implementing any of aspects 1-22.
Aspect 24 is an apparatus for wireless communication including means for implementing any of aspects 1-22.
Aspect 25 is a computer-readable medium storing computer executable code, the code when executed by at least one processor causes the at least one processor to implement any of aspects 1-22.

What is claimed is:

1. An apparatus for wireless communication at a user equipment (UE), comprising:
a memory; and
at least one processor coupled to the memory and configured to:
receive, from a base station, downlink control information (DCI) including at least one of a downlink assignment index (DAI) indicator or a transport block (TB) counter indicator;
determine, based on the at least one of the DAI indicator or the TB counter indicator, a number of acknowledgment/negative acknowledgment (ACK/NACK) bits for a hybrid automatic repeat request (HARQ) codebook; and
transmit, to the base station, the HARQ codebook including the number of ACK/NACK bits.

2. The apparatus of claim 1, wherein the at least one processor is further configured to determine, based on the at least one of the DAI indicator or the TB counter indicator, whether at least one previous DCI is not received.

3. The apparatus of claim 2, wherein the number of ACK/NACK bits includes one or more NACK bits that correspond to one or more TBs of the at least one previous DCI when the at least one previous DCI is not received.

4. The apparatus of claim 3, wherein the at least one previous DCI that is not received includes at least one of consecutive DCI that is not received or non-consecutive DCI that is not received.

5. The apparatus of claim 3, wherein the TB counter indicator indicates a number of the one or more NACK bits to include in the HARQ codebook for the at least one previous DCI that is not received.

6. The apparatus of claim 1, wherein the TB counter indicator indicates a total number of P TBs in a most recent number of K previous DCI, the K previous DCI indexed based on the DAI indicator.

7. The apparatus of claim 6, wherein K=2ⁿ⁻¹ when the DAI indicator includes n bits.

8. The apparatus of claim 1, wherein a number of P bits for the HARQ codebook corresponds to P=p*T, where Tis a value of the TB counter indicator and p is a configured value associated with a modular number.

9. The apparatus of claim 1, wherein a value T of the TB counter indicator corresponds to T=P−K, where P indicates a number of bits for the HARQ codebook and K indicates a number of most recent previous DCI indexed based on the DAI indicator.

10. The apparatus of claim 1, wherein the at least one processor is further configured to determine a location of the number of ACK/NACK bits in the HARQ codebook based on the TB counter indicator.

11. The apparatus of claim 1, wherein the at least one processor is further configured to generate the HARQ codebook to include the number of ACK/NACK bits, the number of ACK/NACK bits corresponding to N total TBs scheduled by a number of DCI transmissions, the DCI included in the number of DCI transmissions.

12. The apparatus of claim 1, further comprising a transceiver coupled to the at least one processor.

13. An apparatus for wireless communication at a base station, comprising:
a memory; and
at least one processor coupled to the memory and configured to:
transmit, to a user equipment (UE), downlink control information (DCI) including at least one of a downlink assignment index (DAI) indicator or a transport block (TB) counter indicator; and
receive, from the UE based on the at least one of the DAI indicator or the TB counter indicator, a hybrid automatic repeat request (HARQ) codebook including a number of acknowledgment/negative acknowledgment (ACK/NACK) bits for the HARQ codebook.

14. The apparatus of claim 13, wherein the number of ACK/NACK bits includes one or more NACK bits that correspond to one or more TBs of at least one previous DCI that is not received from the base station.

15. The apparatus of claim 14, wherein the at least one previous DCI that is not received from the base station includes at least one of consecutive DCI that is not received from the base station or non-consecutive DCI that is not received from the base station.

16. The apparatus of claim 14, wherein the TB counter indicator indicates a number of the one or more NACK bits to include in the HARQ codebook for the at least one previous DCI that is not received from the base station.

17. The apparatus of claim 13, wherein the TB counter indicator indicates a total number of P TBs in a most recent number of K previous DCI, the K previous DCI indexed based on the DAI indicator.

18. The apparatus of claim 17, wherein K=2ⁿ⁻¹ when the DAI indicator includes n bits.

19. The apparatus of claim 13, wherein a number of P bits for the HARQ codebook corresponds to P=p*T, where Tis a value of the TB counter indicator and p is a configured value associated with a modular number.

20. The apparatus of claim 13, wherein a value T of the TB counter indicator corresponds to T=P−K, where P indicates a number of bits for the HARQ codebook and K indicates a number of most recent previous DCI indexed based on the DAI indicator.

21. The apparatus of claim 13, wherein the number of ACK/NACK bits corresponds to N total TBs scheduled by a number of DCI transmissions, the DCI included in the number of DCI transmissions.

22. The apparatus of claim 13, further comprising a transceiver coupled to the at least one processor.

23. A method of wireless communication at a user equipment (UE), comprising:
receiving, from a base station, downlink control information (DCI) including at least one of a downlink assignment index (DAI) indicator or a transport block (TB) counter indicator;
determining, based on the at least one of the DAI indicator or the TB counter indicator, a number of acknowledgment/negative acknowledgment (ACK/NACK) bits for a hybrid automatic repeat request (HARQ) codebook; and
transmitting, to the base station, the HARQ codebook including the number of ACK/NACK bits.

24. The method of claim 23, further comprising determining, based on the at least one of the DAI indicator or the TB counter indicator, whether at least one previous DCI is not received.

25. The method of claim 24, wherein the number of ACK/NACK bits includes one or more NACK bits that correspond to one or more TBs of the at least one previous DCI when the at least one previous DCI is not received.

26. The method of claim 25, wherein the TB counter indicator indicates a number of the one or more NACK bits to include in the HARQ codebook for the at least one previous DCI that is not received.

27. The method of claim 23, further comprising generating the HARQ codebook to include the number of ACK/NACK bits, the number of ACK/NACK bits corresponding to N total TBs scheduled by a number of DCI transmissions, the DCI included in the number of DCI transmissions.

28. A method of wireless communication at a base station, comprising:
transmitting, to a user equipment (UE), downlink control information (DCI) including at least one of a downlink assignment index (DAI) indicator or a transport block (TB) counter indicator; and
receiving, from the UE based on the at least one of the DAI indicator or the TB counter indicator, a hybrid automatic repeat request (HARQ) codebook including a number of acknowledgment/negative acknowledgment (ACK/NACK) bits for the HARQ codebook.

29. The method of claim 28, wherein the number of ACK/NACK bits includes one or more NACK bits that correspond to one or more TBs of at least one previous DCI that is not received from the base station.

30. The method of claim 28, wherein the number of ACK/NACK bits corresponds to N total TBs scheduled by a number of DCI transmissions, the DCI included in the number of DCI transmissions.
